(19) United States
(12) Patent Application Publication
(10) Pub. No.: US 2003/0052912 A1
(43) Pub. Date: Mar. 20, 2003

(54) Method and system for cell rendering and manipulation

(76) Inventors: John F. Bowman JR., Sterling, VA (US); Dennis G. Defensor, McLean, VA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/102,965

(22) Filed: Mar. 22, 2002

Related U.S. Application Data
(60) Provisional application No. 60/278,733, filed on Mar. 23, 2001.

(51) Int. Cl. G09G 5/00

(52) U.S. Cl. 345/738

(57) ABSTRACT

A method and system for an active cell rendering engine, including a web server, a rendering engine, an application layer, and a data layer. The application layer includes cell applications. The data layer has data sources corresponding to the cell applications. One of the cell application is started pursuant to a request from the rendering engine, and returns formatted data, based on the data source in the data layer, to the rendering engine. The rendering engine, responsive to a copy request, provides a copy of one of the cell applications to the another page. The copied cell application includes a reference back to the page, so that modifications to the page appear in the copied cell application in a real-time fashion. Users can thus copy cells to pages, and construct pages utilizing copied cells, in order to keep real-time updated content in a cell on a page. The application layer and data layer can be provided in a configuration separate from the web server and rendering engine.

### CROSS-REFERENCE

The present invention claims priority to and incorporates by reference the following pending applications: U.S. Ser. No. 60/278,733, entitled “Method and System for Cell Rendering and Manipulation” filed on Mar. 23, 2001, and U.S. Ser. No. 09/543,756 [Attorney Docket No. 28779-2], entitled “Method and System for Cell Rendering and Manipulation” filed on Apr. 5, 2000.

### BACKGROUND OF THE INVENTION

1. Field of Invention

This invention relates to creating user-personalizeable web sites and portals for Internet and intranet applications, or documents for desktop applications. Particularly, it relates to creating, aggregating and sharing content utilizing “active cells.” This invention breaks down a Web page (or document) into smaller page components called “active cells” which has the following functional attributes: (1) The content of an ActiveCell from one web page may be copied to an ActiveCell on another web page, (2) Any update or change to the original ActiveCell will dynamically update the content of all ActiveCell copies, and (3) Users can copy, create and combine ActiveCells to create personal, group and public portals or web sites. The implementation of this invention is specifically accomplished through a server, which makes it client-independent in its architecture. The target client can be a desktop, a mobile wireless device, Internet appliance or similar devices.

2. Description of Related Art

The connectability of web sites using hypertext and the vast availability of content are the reasons that the Internet has been incredibly successful. The Internet community and the Internet industry have pushed the envelope in many instances. Particularly, methods for personalizing web sites and portals have come up against the edge of the envelope.

Presently, there is a need in the Internet community and industry for a fully-flexible method to personalize content either in a commercial or personal setting. There is also a very great need to aggregate content and Internet links as determined by the individual user.

Current solutions fall short of the goal. In part, these systems fail because the scope of the solution was limited and did not provide for true personalization. In those cases, the site owner or publisher was responsible for providing the set choice of content which limits the end user to existing configurations. The user is offered a pre-configured page with limited ability to change the content and format of the page. YAHOO™ is a convenient example of conventional systems which all seem to have the same problems. More specifically, there is little or no sharing and user-collaboration in the development and distribution of content in smaller page components. These are all very significant deficiencies which centralize the control of viewable content in the conventional web developers or publishers, seriously limiting the personal choice of the user.

Later solutions may allow for distribution and sharing of content in smaller packets than a web page, but these solutions are not fully server-based and rely on the attributes of specific client platforms (client-dependent architecture), which significantly limits the user's ability to access the content from any client platform. Most of these solutions offer pre-set content in smaller portions but do not allow the users to create their own page components.

No traditional portal or web site provides a way for the user to build their own portals using active cell page components that can be copied and shared, and made accessible through any client device (client-independent architecture). There is a further need for content in these format to be dynamically updated. Furthermore, there is a need to a flexible method of personalization and aggregation of content that is not limited by the web site or portal publisher.

There still remains a strong need in the industry to allow the individual user the capability to access, develop, distribute, copy and share content in smaller page components (such as Active Cells) from a server or servers, using any client device such as desktop computers, mobile wireless, Internet appliances and other similar devices all across the Internet and intranet sites in the World Wide Web.

### BRIEF SUMMARY OF THE INVENTION

According to the invention, there are provided method and system for a cell rendering engine. It can include, for example, a web server. There is also provided a rendering engine, receiving information from, for example, the web server. Further, there is an application layer, the application layer including at least one cell application. A data layer includes at least one data source, the data source relating to the cell application. The cell application is started pursuant to a request from the rendering engine, and returns formatted data to the rendering engine responsive to the request from the rendering engine. The rendering engine further includes information indicating a cell that corresponds to data passed in from, for example, the web server. The rendering engine initiates the one of the cell applications corresponding to the data type.

There are provided several cell applications and several data sources, each cell application corresponding to a type of data, and each data source corresponding to one of the cell applications.

In one embodiment, the web server and rendering engine correspond to one page, and the rendering engine, responsive to a copy request, provides a copy of one of the cell applications to another page. The page may be on the same or a different web server.

According to one embodiment of the invention, there is provided a device and method for providing cells for a cell rendering and manipulation engine, including an application layer, with least one cell application; and a data layer including at least one data source, each data source corresponding to one of the cell applications.

In another embodiment of the invention, there is provided a device and method for using cells in a cell rendering and manipulation engine, including a web server; and a rendering engine, receiving information from the web server so that the rendering engine starts a foreign cell application and receives formatted data from the foreign cell application.

### BRIEF DESCRIPTION OF THE DRAWINGS

The invention is described in connection with the drawings.

FIG. 1 is a block drawing of a system having cell rendering and manipulation engine, according to an embodiment of the present invention.

FIG. 2 is a block drawing illustrating data flow in the application layer of the cell rendering and manipulation engine, according to an embodiment of the present invention.

FIG. 3 is a block drawing illustrating several cells on a page, according to an embodiment of the present invention.

FIG. 4 is a block drawing illustrating a data family table of the rendering engine, according to an embodiment of the present invention.

FIG. 5 is a block drawing illustrating the copying of cells from one site to another site, according to an embodiment of the present invention.

FIG. 6 is a block drawing of a system having cell rendering and manipulation engine, according to an embodiment of the present invention.

FIG. 7 is a block drawing of a system having cell rendering and manipulation engine, according to an embodiment of the present invention.

### DETAILED DESCRIPTION

FIG. 7 illustrates a block drawing of a system having cell rendering and manipulation engine, according to an embodiment of the present invention. As shown in FIG. 7, the system 700 includes a rendering engine 703, one or more cell applications 705, and one or more corresponding data sources 707. In this embodiment, the rendering engine 703 is associated with the presentation layer 709. The one or more cell applications A through D 705 are associated with the application layer 711. The one or more data sources A through D are associated with the data layer 713.

The system 700 generates cell-based documents, such as for example, desktop-based documents (e.g., having a rich text format (RTF) or hyperlinks) or network-based documents (e.g., based on web servers within a network). Examples of these various types of system are discussed below in connection with other figures.

The rendering engine 703 can be either software and/or hardware configured to receive data having a common data format from a cell application 705, merge the received data with a template and output a document based on the template and received data. To perform these functions, the rendering engine 703 can, for example, perform a copy function (as described below in the section entitled “Copy Function”) and a manipulation function.

The manipulation function can include, for example, the passing of directives received from a user (e.g., a user selection of a minimize icon, a close icon or window arrows to move a cell) to the rendering engine so that a specific cell within a particular page can be maintained. Thus, a user-specified view of a particular window (or cell within a window) can be maintained during subsequent display of the cell and/or window having the cell. Note that unlike intermediary-based manipulation of cells (such as, for example, customizable portals), the manipulation function of the rendering engine can allow changes from a user to be directly associated with a page without an intermediary. Note that although the rendering engine is sometimes referred to herein as the term “cell rendering and manipulation engine”, the manipulation function of the rendering engine is optional.

A cell application 705 can be either software and/or hardware configured to receive data from a data source 707, convert the received data to a common data format and pass the converted data to the rendering engine 703. The common data format of the converted data can be, for example, a standardized markup language such as the Active Cell Markup Language (ACML) described below. Of course, other common data formats are possible such as different markup languages or variations to the ACML described below.

In certain embodiments, the cell applications can have a bi-directional functionality. More specifically, data from a client can be passed through the rendering engine and restored to the originating data source through the cell application. In other words, certain cell types (which are derived from the data of the data sources) allow a client (or user) to modify the underlying data of the cell and to restore that data to the originating data source. Such cell types can be, for example, a system cell, which allows a client (or user) to modify the data items associated with that cell, or a user cell, which allows a client (or user) to modify the data items and data objects associated with that cell. Additional details relating to the data items and data objects (as well as data types) of a cell are discussed below in connection with the section entitled “Datasource.”

Data sources 707 have the data that the cell is to use. The data can include, for example, a hard-drive identifier, a file system or a Universal Resource Locator (URL). Additional details of the data sources 707 are discussed below in the section entitled “Datasource.”

SERVER-BASED EMBODIMENT

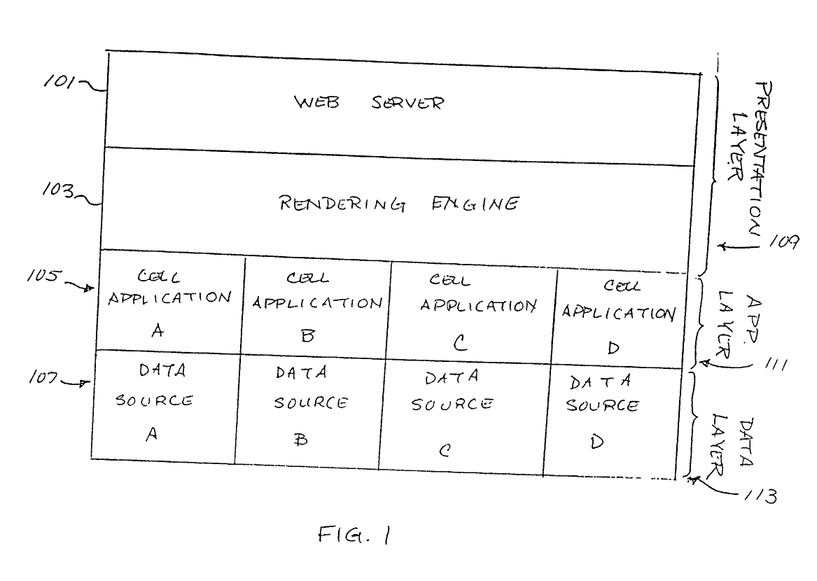

A system having a cell rendering and manipulation engine, according to another embodiment of the present invention, is described in connection with FIG. 1. The engine generally includes a web server 101, a rendering engine 103, one or more cell applications 105, and one or more corresponding data sources 107.

The web server 101 and rendering engine 103 constitute the presentation layer 109. The one or more cell applications A through D 105 constitute the application layer 111. The one or more data sources A through D 107 constitute the data layer 113.

The web server 101 can be a conventional standard web server. The traditional function of a web server is to get a page. The web server 101, for example, can be able to be ported to any operating system. For example, an appropriate standard web server is IIS (available from Microsoft).

A conventional system requires only one web server, but it is not inconceivable that multiple web servers could be provided or that web servers could be clustered on multiple systems.

The rendering engine 103 places cells where they are desired on the HTML page, usually at a position defined by the user. Further, the rendering engine 103 starts a cell application 105. The rendering engine will be described in further detail below.

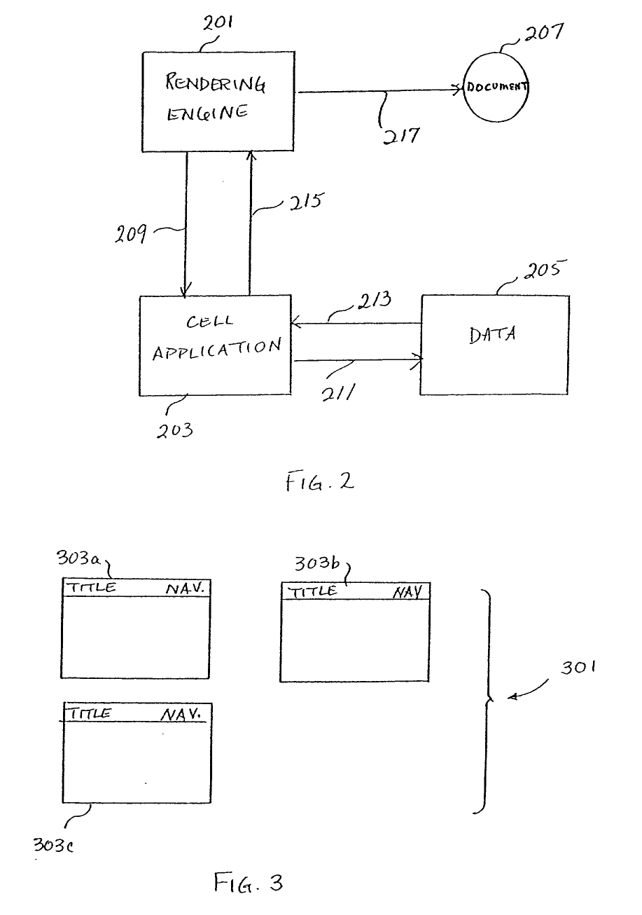

The application layer 111 can handle multiple cell applications, as discussed in additional detail below in connection with FIG. 2. The rendering engine begins the cell application, and passes in parameters to the cell application. The cell application 105 obtains data from the data source referenced by the data source corresponding to the particular cell application, requests and receives raw data (if any), formats the data, and send the formatted data to the rendering engine. The rendering engine 103 then positions the cell from the user's page.

The data layer 113 includes a data source 107 corresponding to each of the cell applications 105. The data source contains information on the location of data, which could be any place from which a cell could access data. These include, for example, a data base, a web server, or a file system.

Advantageously included in the rendering engine 103 is a data family table, which indicates where the data is to be located. For example, it would indicate a URL for a data source or a directory path for a file, or a connect string for a data base—in other words, for anything that is addressable, the address can be placed in the data family table.

RENDERING ENGINE

The rendering engine is described here in greater detail. The rendering engine 103 starts a cell application for each cell that is to be located on the page. The rendering engine 103 passes to the cell application 105 basic information. In the preferred embodiment, the preferred information include the user identification (corresponding to the user that requested the page or a system user identification); and a connect string (a location where the data may be located, for example, a data source for what is to be inserted into the cell on the page).

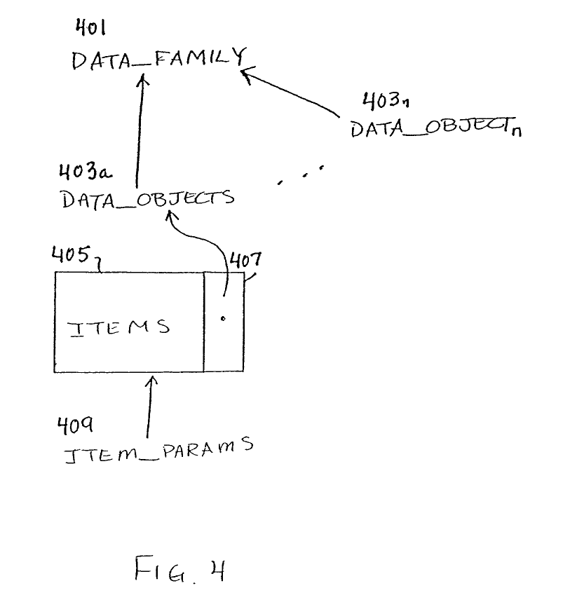

Reference is made to FIG. 3, illustrating several cells 303a through c on a page 301. Note that a cell 303 typically includes a title of the object and a navigation button. A cell can be dragged and moved and placed on a page, and so forth.

The rendering engine, illustrated in FIG. 1, receives back from the cell application, the title and cell content. The rendering engine inserts the navigation buttons, since the navigation buttons traditionally are owned by the rendering engine. The rendering engine performs the positioning of the cell, the splicing (as further described below) insertion of supporting pieces (for example, category navigation, and navigation path), and passes the full page back up to the web server 101.

Note that there typically would be an instance of the rendering engine 103 corresponding to each page. Further note that a traditional web server is preferably used to get each page.

APPLICATION LAYER

Reference is made to FIG. 2, illustrating the flow of data between the rendering engine 201, the cell application 203, the data 205 and the page 207. Advantageously there is an application layer for each instance of a rendering engine 201. The application layer includes one or more cell applications 203. The data 205 that flows back to the cell application is obtained from the data source corresponding to a particular cell application.

In the preferred embodiment, each cell application 203 is designed for a particular type of data, and therefore inherently expects a certain type of data. Conversely, a cell application does not necessarily know where to locate the particular data.

A cell application could be an object, for example a MICROSOFT™ COM object. A cell application is preferably an independent application, capable of running on its own. A cell application may be dynamically linked to the rendering engine. That is, a rendering engine can add more cell applications and remove them without having been previously linked. Thus, the rendering engine can initiate and run any necessary or desired number of cell applications. A cell application can have standard calls built in. The cell application can be considered to be a content provider, in a general sense. That is, it gets the data, formats the data, and passes the formatted data (content) back to the rendering engine.

It is advantageous to have a different type of cell application for each different type of data. For example, there could be provided an image/text cell, for handling images and text. There could be an address book cell, for handling a conventional address book. Similarly, there could be provided a cell application for each of the following: favorites, news, and link directories.

Each cell application thus corresponds to a particular type of information or data that users typically have displayed in the respective cell type. Referring specifically to FIG. 2, the rendering engine starts a particular cell application 203 (step 209), wherein the cell application 203 corresponds to the type of cell that the user wishes to initiate. The cell application 203 refers to the data source, and then obtains the data 205 from the data source (step 211). The data is returned to the cell application (step 213). The cell application formats the data as described below and passes the formatted data back up to the rendering engine 201 (step 215). The rendering engine 201 then places the formatted cell at the appropriate location on the page 207 (step 217).

If there are multiple cells, the rendering engine would initiate a cell application for each of the cells.

All data that is merged with the templates can be in a common data format, such as for example a format called Active Cell MarkUp Language (ACML). This was developed by Abyan as a common data format. It is based on XML standards and has its own unique sets of tags and parameters.

The purpose of using this format is to make sure that the data to be merged with the templates is utilizing a common data format. By ensuring that, one can write applications that are device independent. Each new device or format to be output by the engine is then a simple matter of creating and applying a new template. This method ensures that application can be written once and delivered to any device or format by changing the templates.

ACML also serves as a control language dictating what applications are run and which templates are used. This guides the rendering engine in placement of cells and applications. By passing the engine, a starting ACML file, a template location the system is then able to create a complete page that be viewed on several different platforms.

The tags are as follows.

### Tags and Parameters

### ACML stands for Active Cell Markup Language

### ACML is a derivative of XML (eXtensible Markup Language)

ACML has eight tags and each tag has a specified list of possible parameters.

| Element | Tag | Type | Parameter | Required | Description |
|---|---|---|---|---|---|
| ACML | <ACML> . . . | Enclosing | version | Required | ACML version number. |
| | </ACML> | | | | |
| TEMPLATE | <TEMPLATE> . . . | Enclosing | name | Required | Name of field to be merged into. |
| | </TEMPLATE> | | template | Required | Name of template part to use. |
| | | | templatebase | Optional | Name of parse template file to be |
| | | | | | used. |
| FILE | <FILE . . . /> | Terminated | file | Required | Name of XML file to be inserted. |
| | | | templatebase | Optional | Name of parse template file to be |
| | | | | | used. |
| APPLICATION | <APPLICATION . . . | Terminated | appname | Required | Name of application to be inserted. |
| | | | Name | Required | Name of field to be merged |
| | | | | | into. |
| | | | Params | Optional | Parameters to be passed to |
| | | | | | application formatted as a |
| | | | | | querystring. |
| | | | templatebase | Optional | Name of new template file to be |
| | | | | | used. |
| VAR | <VAR> . . . | Enclosing | name | Required | Name of field to be merged into. |
| | </VAR> | | | | |
| CUSTOM | <CUSTOM . . . /> | Terminated | celltemplate | Required | Name of the cell type to be used to |
| | | | | | get the template for the contents of |
| | | | | | the cell. |
| | | | name | Required | Name of field to be merged into. |
| | | | template | Required | Name of template part to be used as |
| | | | | | the cell frame. |
| | | | templatebase | Optional | Name of parse template file to be |
| | | | | | used. |
| | | | column | Required | Number of custom column to be |
| | | | | | generated. |
| PARAM | <PARAM> . . . | Enclosing | type | Required | Part of cell to assign parameter to. |
| | </PARAM> | | | | Either ITEM or OBJECT. |
| | | | name | Required | Name of the parameter to be set. |
| SYSTEM | <SYSTEM . . . /> | Terminated | name | Required | Name of field to be merged into and |
| | | | | | the name of the section to be |
| | | | | | generated. |
| | | | celltemplate | Required | Name of the cell type to be used to |
| | | | | | get the template for the contents of |
| | | | | | the cell. |
| | | | template | Required | Name of the template part to be |
| | | | | | used as the cell frame. |
| | | | templatebase | Optional | Name of parse template file to be |
| | | | | | used. |
| CELL | <CELL . . . /> | Terminated | celltemplate | Required | Name of cell template to use |
| | | | Name | Required | Name of field to be merged into |
| | | | Templatebase | Optional | Name of the parse template file to |
| | | | | | be used. |

The start of the tag content is marked by “<” followed by an ACML tag name and a closing “>”. Unless otherwise noted, the end of the tag content is marked by “</” followed by the same tag name used in the start section and a closing “>”.

Example: <My Tag></My Tag>.

Tags that do not require end tags use terminated tags, a“/” is placed before the closing “>” of the start tag.

Example: <My Tag/>

White space before the “/>” is optional.

Each tag contains at least one required parameter value. These parameters are placed in the marker indicating the start of the tag. The parameter value must be surrounded by quotes. Just like in XML, white space is used to separate the tag name from its parameters.

With the exception of FILE and APPLICATION, all elements have start tags and end tags. FILE and APPLICATION feature “terminated” end tags “/>”.

A C M L

The <ACML></ACML> tag represents the version of ACML being used. It is found at the beginning and end of a document.

ACML has one parameter:

version—This represents the version number of ACML being used and is always contained in quotes.

Within ACML tags reside all other tags.

Example:

<ACML version=“1.0”>

. . . other tags . . .

</ACML>

TEMPLATE

The TEMPLATE tag denotes which template to use and where to merge the template.

TEMPLATE has three parameters:

name—Name of the merge field. This merge field name is the location where the template will be merged. If this is the first template used in the ACML structure the “merge field” name is not used, but need to be defined; if this is a TEMPLATE tag within another TEMPLATE tag then the “merge field” name is located in the first level TEMPLATE.

template—This is the name of the template part in a parsed template file to be used.

Templatebase—Name of the parsed template file to be used.

Example:

<ACML version= “1.0”>

<TEMPLATE name = “merged field” template = “template used”>

. . . .
</TEMPLATE>
</ACML>

FILE

The FILE tag pulls other ACML code and template files into a template.

FILE has two parameters:

file—ACML file to be accessed and inserted.

templatebase (optional)—Name of the parsed template file to be used.

Example:

<ACML version= “1.0”>

<TEMPLATE name = “merge field” template= “template used”>
<FILE file= “ACMLfile” templatebase= “merge-templatel” />
</TEMPLATE>

</ACML>

APPLICATION

The APPLICATION tag pulls another ACML template and runs an object/application within a template. When an object/application is run on one template it is returned in ACML format and replace the original APPLICATION tag.

APPLICATION has four parameters:

name—The field within the template being used which will use the application/object.

appname—The COM id to of the application to be run (ie. MyApp.MyApplication)

templatebase (optional)—Name of the parsed template file to use.

params (optional)—Parameters (in QueryString format) to be passed to application.

Example:

<ACML verion=”1.0”>
<TEMPLATE name = “merge field” template= “template used”>

<APPLICATION name= “merge field” application=

“application/object to run” templatebase= “merge-template” />
</TEMPLATE>
</ACML>

VAR

The VAR tag defines the name of a variable and assigns it a value used in conjunction with the TEMPLATE tag.

VAR has one parameter:

name—The merge field, which will contain the assigned value, located within the in the TEMPLATE tag.

Example:

<ACML version= “1.0”>

<TEMPLATE name = “merge field” template= “template used”>

<VAR name= “merge field”> assigned value </VAR>
<VAR name= “merge field”> assigned value </VAR>
<VAR name= “merge field”> assigned value </VAR>

</TEMPLATE>

</ACML>

CUSTOM

The custom tag inserts a custom column into the document. Columns are inserted independently and identified with the column parameter. Cells are contained with a cell frame, which defines the border, button location, and cell content location.

CUSTOM has five parameters:

name—Merge field within the template that will display the custom column.

template—Name of the template to use as the cell frame.

celltemplate—Name of the celltype that contains the cell content templates.

column—Number of the custom column to be merged.

templatebase (optional)—Name of the template file to be used.

Example:

<ACML version=”1.0”>

<TEMPLATE name = “merge field” template= “template used”>
<CUSTOM name= “merge field” template = “template to use”

celltemplate= “cell template to use” column= “number of columns” />

<TEMPLATE>

</ACML>

PARAM

The PARAM tag is only used within the ACML returned by cell applications within system, custom, or page areas. This tag is used to set either Data Item or Object parameters that are used by cell application.

PARAM has two parameters:

name—The field within the template being used which will use the application/object.

type—Denotes which cell type to assign values to—ITEM or OBJECT.

Example:

<ACML version=”1.0”>

<PARAM name= “merge field” type= “item”> assigned value

</PARAM>

<PARAM name= “merge field” type= “object”> assigned value

</PARAM>
</ACML>

SYSTEM

The SYSTEM tag defines the cells that are offered as system area cells.

SYSTEM has four parameters:

name—Merge field within the template that will display the system cell.

template—Name of the page template to use.

celltemplate—Name of the cell template to use to display the system data.

templatebase (optional)—Name of the parsed template file to be used.

Example:

<ACML version=”1.0”>

<TEMPLATE name = “merge field” template= “template used”>

<SYSTEM name= “merge field” template = “template to use”

celltemplate= “cell template to use” />
</TEMPLATE>

</ACML>

CELL

The CELL tag inserts a singe cell onto a page.

CELL has three parameters:

name—Merge field within the template that will display the system cell.

celltemplate—Name of the cell template to use to display the system data.

templatebase (optional)—Name of the parsed template file to be used.

Example:

<ACML version=”1.0”>

<TEMPLATE name = “merge field” template= “template used”>

<CELL name= “merge field” celltemplate= “cell template to

use” />
</TEMPLATE>

</ACML>

DATASOURCE

Reference is made back to FIG. 1. The data source 107 indicates the data that the cell is to use. The data could include, for example, a hard-drive, a file system or a URL. The data could be stored in a data base. Given a particular address, it is possible to access the data at a particular data source location and retrieve the data. For example, if the data source is a file descriptor, the cell application could reference the data source and obtain the file, on which the cell application would perform further applications.

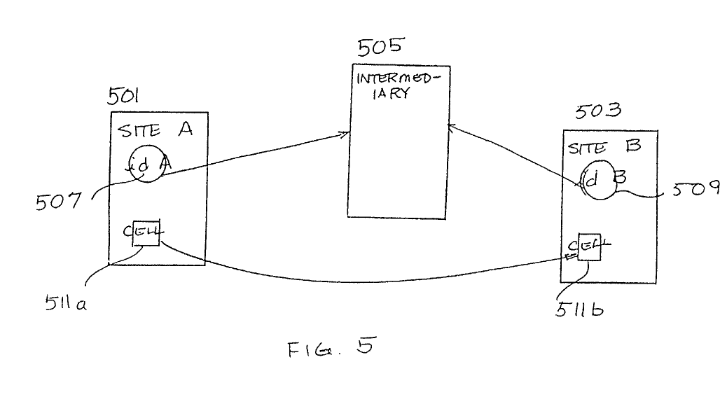

Reference is now made to FIG. 4. The rendering engine determines which cell application to run based on the expected data type. Advantageously, the rendering engine maintains a data family table. The data family table can include, for example, a family identifier, family name, family description, object name, and one or more parameters (e.g., a connect string), as in the following examples:

| | |
|---|---|
| Record 1: | |
| -ID: | 1 |
| -Name: | Test Objects |
| -Description: | Items created for testing the engine |
| -Object: | project1 |
| -Connect String: | DRIVER={SQL |

Server};SERVER=data_server;UID=admin;PWD=

| | |
|---|---|
| Record 2: | |
| -ID: | 2 |
| -Name: | Favorites |
| -Description: | Allow you to store you personal sites |
| -Object: | favorites |
| -Connect String: | DRIVER={SQL |

Server};SERVER=data_server;UID=admin;PWD=

| | |
|---|---|
| Record 3: | |
| -ID: | 3 |
| -Name: | Link Lists |
| -Description: | Displays entire lists of links |
| -Object: | UserLinks |
| -Connect String: | DRIVER={SQL |

Server};SERVER=data_server;UID=admin;PWD=

For each cell application, the following information includes examples of information that can be advantageously stored: the position on the page, and extra parameters. The extra parameters and position on a page can be stored in a position table and a parameters table. The parameters table can include, for example, generic extra parameters, since the extra parameters will be dependent on the cell to which they correspond.

Each piece of user defined data is a separate data object 403a through 403n. Consider for example, a user that has favorites 1 and favorites 2. Each data object 403a through 403n links back to a data family 401. In this case, the favorites 1, 2 would correspond to data objects 403a through 403n. The data family would be “favorites”. Each item 405 contains information about where the object is located on a page, and what position it is in. The item also includes a link 407 to the data object. Advantageously, there is an item 405 for each open cell on a page. Also included are item_params 409 (item parameters) that indicate parameters, if any, for each cell. Each cell might or might not have some item parameters. In any event, if there are item parameters 409 they are linked to the items 405. An item parameter links to an item. Item parameters are optional, and probably would not be included in an address book or resource/tools for example, since there is no additional information needed for rendering such cells. The item parameters are ultimately passed to the cell application.

Said another way, the cell-based document generation techniques described herein can be structured in object-oriented hierarchies. For example, a data type (or data family) can have its own parameters; data objects inherent the properties from the associated data type (or data family) and can have its own parameters; the data items inherent the properties from an associated data object and can have its own parameters. A data type can be, for example, a type that can contain images and/or text. This data type can be inherited by one or more data objects where each data object contains its own images and/or text. A given data object can be inherited by one or more data items where each data item is a specific cell in a specific document in a specific location within that page. The parameters associated with the item are generally used for display options that can be changed without affecting the inherited data object.

COPY FUNCTION

The copy button is a conventional button in a traditional user interface.

However, the copy function as implemented in connection with the cell rendering and manipulation engine permits a user to select a cell, click on the copy button, chose a page and a location for the cell, and place that cell on that location on that page. A user can thereby copy a cell to a different page (i.e., a destination page). The destination page could be on the same web server as the source cell, or the destination page could be on another compatible web server.

The copy function can readily be accomplished by creating a data item that inherits the data object of the cell being copied. This allows the owner of the data object to make changes to it that are reflected in all copied versions of the cell regardless of where they have been copied to. It also allows the copier of the cell to make certain modifications to the cell such as position on a page and item parameters that reflect display changes for that particular cell without affecting the original data object.

If the cell has been copied to a different system, the data item would also include the location of the source system (i.e., the system from which the copied cell originated).

Consider an example of the copy function. A number of web sites are very content rich, and wish to distribute their content onto a third party portal. For example, a news site has very rich content. The news that is of interest can be placed into a cell at the news site, and copied via the copy function to a third party portal. The third party portal will then include a cell on which the news is updated, real time, as news is changed at the cell appearing on the news site.

Reference is now made to FIG. 5. FIG. 5 illustrates a cell which is copied from site A 501 to site B 503. The cell on site A is cell 511a, and the cell on site B is cell 511b.

A user who is browsing or otherwise visiting site A 501 can select a cell, and click on a copy button. The user can then select site B 503. Because the copy function is to a foreign site, an intermediary 505 is referenced by site A 501. Said another way, because site A 501 is located on a server that is different from a server on which site B 503 is located, intermediary 505 is referenced by site A 501. For this example, assume that the user has previously been registered into the cell rendering and manipulation engine. Therefore, the user has an identifier on site A 501, while its identifier on site B 503 is undetermined. The intermediary 505 determines the corresponding user identification on site B 503, so that the identifiers corresponding to the user on both site A and site B are transferred into the intermediary. The cell copy would then pass through the intermediary. On subsequent copies, the identification transfer or handshake is not necessary. In one embodiment, the central intermediary can be a separate site, provided for user convenience and to provide greater confidence about transfers of user identifiers.

SHARING FUNCTION

The cell rendering and manipulation engine also provides a method and system for cells to be shared. A cell can be created with an indication that the cell's content is to be shared. Typically, the sharing information would indicate a group that is to share the information or particular persons that are to share the information. Indicating information that is to be shared with a particular person becomes difficult where a particular person may have unique identifiers which are different among different sites. Therefore, the person must be associated with one or more of the user identifiers.

In order to share a cell, the cell includes information indicating the persons with which it may be shared. Each of those persons is associated with one or more user identification. This could be done, for example, in a table. If a particular user is registered with the system, it is possible for the registered user to indicate that it is a particular person and that there is a particular user identification or more than one user identification which corresponds to that particular user.

The cell rendering and manipulation engine has a number of uses, including portals, intranet, and internet servers. A server or portal will use the cell rendering and manipulation technology in order to create custom pages with custom content.

If a user of a cell rendering or manipulation engine is interested solely in providing content, the content provider system could be equipped with the application layer and data layer. In that situation, the web server and rendering engine would be unnecessary. Since the content provider would be making cells available for users, users visiting the site would select one or more cells and copy the particular cell.

For example, a book seller could have several cells, one of which is a book of the month club. Users that are interested in keeping up to date with the book of the month would copy in the cell corresponding to the book of the month. The cell at the user's site would include real time information on the book of the month club.

On an intranet server, a company department, for example, could set up a page that includes certain cells that would be of interest to the particular department. Note that some of these cells may be of interest throughout the company, such as a message from the CEO. Information that is posted to any particular data object would then be automatically updated at the destination cell.

It is also possible that a user of the cell rendering and manipulation engine would not include any cells. In that event, the user would include the web server and the rendering engine layers. All cells would be foreign.

CELL SERVER APPLICATION AND RELATED EMBODIMENT

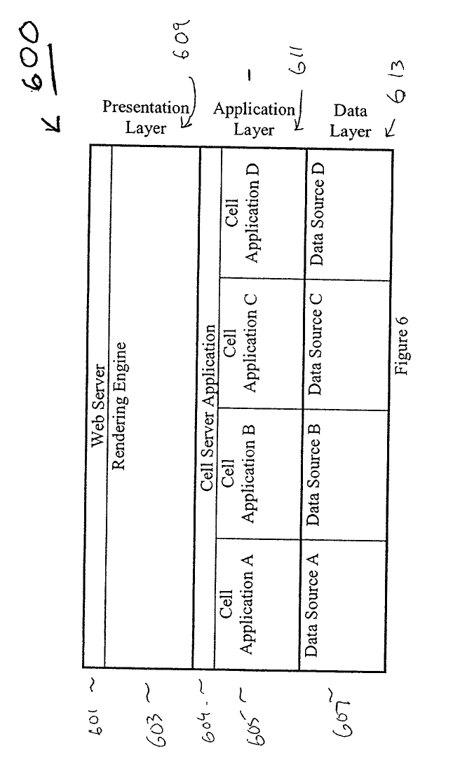

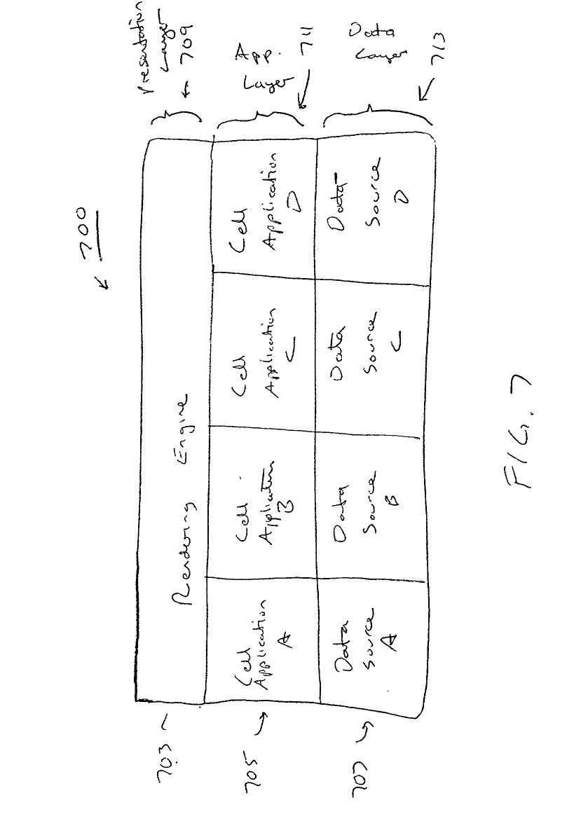

FIG. 6 is a block drawing of a system having cell rendering and manipulation engine, according to an embodiment of the present invention. As shown in FIG. 6, the system 600 includes a web server 601, a rendering engine 603, a cell server application 604, one or more cell applications 605, and one or more corresponding data sources 607. In this embodiment, the web server 601 and the rendering engine 603 is associated with the presentation layer 609. The cell server application 604 and the one or more cell applications A through D 605 are associated with the application layer 611. The one or more data sources A through D are associated with the data layer 613.

The cell server application 604 can separate the cell applications 605 of the application layer 611 from the presentation layer 609. The cell server application 604 is hierarchically located between these the cell applications 605 of the application layer 611 from the presentation layer 609 and facilitates communication between them. The rendering engine 603 of the presentation layer 609 sends information relevant to the user's display capabilities and requests a cell application 605 be run. Based on this information, the cell server application 604 chooses a template for the cell and runs the cell application 605. The template and the ACML data returned from the cell application 605 are returned to the presentation layer 609.

The cell server application 604 allows cells to be copied between different systems (e.g., between different servers where a source server has a cell to be copied and a destination server receives the copied cell). The system can be a combination of rendering engine and/or cell server controlled by a single entity. Copying a cell between systems becomes a matter of the user clicking on the copy button and selecting a destination system and page. For example, when the rendering engine on the destination system then tries to display that cell it would obtain the ACML and the template from the foreign cell server and merge it onto that page.

Said another way, the rendering engine 603 can log into the cell server application 604. For example, the rendering engine 603 can be located on a web server 601 and the cell server application 604 can be located on one or more cell servers (not shown). If needed, the rendering engine 603 can be authenticated by cell server application 604. The cell server application 604 can pass parameters to a cell application 605 and the cell application 605 can execute (in either order) thereby passing data (in a common data format) and a template back to the cell server application 604. The cell server application 604 can transport the received data (in a common data format and the template to the rendering engine 603.

Authentication

To insure security when cells are passed from a foreign cell server (not owned by the presentation layer) to a presentation layer, a unique authentication code can be generated when the cells are copied. Said another way, when a cell is copied by the copy function described above from one entity to a foreign entity (e.g., from one server to a different server), an authentication code can be generated. This authentication code can be used from this point forward in time for that user. This authentication code is unique between the two systems for that user. Any other cell servers that supply cells to the presentation layer would have a different code. Thus, when the copied cell is subsequently displayed (or accessed, processed, etc.), the presentation server and the foreign cell server can pass credential information (i.e., the authentication code) to ensure proper copying of the cell. This authentication process is described in further detail below.

The authentication process allows cell applications from physically different cell servers to be transported to the rendering engine within the presentation layer. The cell applications of the application layer can be located on physically different cell servers. Consequently, each cell server is foreign from the perspective of the cell server(s), as well as the entity at which the rendering engine is located (e.g., a web server). A user's identity at one cell server typically will not be known by another cell server. Said another way, the user identity (e.g., including a user name and password at a cell server) at one cell server typically not be known by another cell server, which will have its own user identity associated with the user at that cell server. Following the example shown in FIG. 5, the user's identity on site A 501 typically will not be known by the cell server of site B 503; and vice versa, the user's identity on site B 503 typically will not be known by the cell server of site A 501. Under the example of FIG. 5, the user can be located, for example, at intermediary 505.

When a cell is copied from one cell server (the “source cell server”) (e.g., site A 501 in FIG. 5) to another cell server (the “destination cell server”) (e.g., site B 503 in FIG. 5), the authentication can also be performed. The rendering engine (e.g., at the intermediary 505) can generate a unique authentication code associated with the source cell server (e.g., site A 501). This unique authentication code can be, for example, a temporary code independent from the user's identifier (or related user name or password). This unique authentication code can be provided to the destination cell server (e.g., site B 503). Thus, as the destination cell server (e.g., site B 503) can subsequently contact the source cell server (e.g., site A 501) with the unique authentication code to verify the authenticity of the cell (and the cell's updates).

The authentication code can be generated in any variety of manners. The authentication code can be based on, for example, an identifier associated with the source cell server, an identifier associated with the destination cell server, a form of the user's identification at the source cell server and a form of the user's identification at the destination cell server. More specifically, for example, the authentication code can include a 32-bit identifier generated by the rendering engine and uniquely associated with the source cell server, a 32-bit identifier generated by the rendering engine and uniquely associated with the destination cell server. The authentication code can also include a 32-bit cyclable redundant code (CRC) of the user name at the source cell server and a 32-bit CRC of the user name at the destination cell server. Thus, in this embodiment, the authentication code can be a 128-bit code having the four above-described portions. In other embodiments, the user name at the source cell server and the user name at the destination cell server can be encrypted by known encryption techniques (e.g., a hash function producing a hash code having a fixed byte length).

While embodiments of the invention have been described, those familiar with the art to which this invention relates will appreciate that various alternative designs and embodiments for practicing the invention are possible, and will fall within the scope of the following claims.

What is claimed is:

1. A cell rendering engine, comprising:
(A) a web server;
(B) a rendering engine, receiving information from the web server;
(C) an application layer, the application layer including at least one cell application; and
(D) a data layer, including at least one data source, said data source corresponding to said cell application.

2. The device as claimed in claim 1, wherein said data source includes an address for the data to be placed into a cell.

3. The device as claimed in claim 2, wherein the cell application is started pursuant to a request from the rendering engine, and returns formatted data to the rendering engine responsive to the request from the rendering engine.

4. The device as claimed in claim 1, wherein the rendering engine obtains user information from the web server, and passes user information to the cell application.

5. The device as claimed in claim 4, wherein the rendering engine further includes information indicating a cell that corresponds to data passed in from the web server, and wherein the rendering engine initiates a cell application corresponding to the data type.

6. The device as claimed in claim 1, wherein there are provided a plurality of cell applications, each of said cell applications corresponding to a type of data, and wherein there are provided a plurality of data sources, each of said data sources corresponding to one of each of said cell applications.

7. The device as claimed in claim 1, wherein the web server and rendering engine correspond to a page, wherein there is provided a second page, and wherein the rendering engine, responsive to a copy request, provides a copy of at least one cell application to the other page.

8. The device as claimed in claim 7, wherein the other page is on the same web server.

9. The device as claimed in claim 7, wherein the other page is on a different web server.

10. The device as claimed in claim 7, wherein the cell application on the other page includes a reference back to at least one cell.

11. The device as claimed in claim 1, wherein a copy function includes a transfer of user identifications on an other site.

12. The device as claimed in claim 1, wherein a cell application may be shared.

13. The device as claimed in claim 12, wherein the person with whom the cell application is shared is verified.

14. A device for providing cells for a cell rendering and manipulation engine, comprising:
(A) an application layer, including at least one cell application;
(B) a data layer including at least one data source, each at least one data source corresponding to the at least one cell application.

15. The device as claimed in claim 14, wherein said data source includes an address for the data to be placed into a cell.

16. The device as claimed in claim 14, wherein the cell application is started response to a request, and returns formatted data.

17. The device as claimed in claim 14, wherein there are provided a plurality of cell applications, each of said cell applications corresponding to a type of data, and wherein there are provided a plurality of data sources, each of said data sources corresponding to one of each of said cell applications.

18. A device for using cells in a cell rendering and manipulation engine, comprising:
(A) a web server;
(B) a rendering engine, receiving information from the web server wherein the rendering engine starts a foreign cell application and receives formatted data from the foreign cell application.

19. The device as claimed in claim 18, wherein the rendering engine obtains user information from the web server, and passes user information to the foreign cell application.

20. The device as claimed in claim 18, wherein the rendering engine further includes information indicating a cell that corresponds to data passed in from the web server, and wherein the rendering engine initiates a foreign cell application corresponding to the data type.

21. The device as claimed in claim 18, wherein the web server and rendering engine correspond to a page, and wherein the rendering engine, responsive to a copy request, provides a copy of at least one foreign cell application to an other page.

22. The device as claimed in claim 21, wherein the other page is on the same web server.

23. The device as claimed in claim 21, wherein the other page is on a different web server.

24. A method for rendering cells in a rendering engine, comprising the steps of:
(A) providing a web server;
(B) in a rendering engine, receiving information from the web server;
(C) in an application layer, providing at least one cell application, said application layer initiating the cell application responsive to a request from the rendering engine; and
(D) in a data layer, providing at least one data source, said data source corresponding to said cell application.

25. The method as claimed in claim 24, wherein said data source includes an address for the data to be placed into a cell.

26. The method as claimed in claim 25, comprising the steps of starting the cell application, responsive to a request from the rendering engine; and returning formatted data to the rendering engine, responsive to the request from the rendering engine.

27. The method as claimed in claim 24, further comprising the step of, in the rendering engine, obtaining user information from the web server, and passing user information to the cell application.

28. The method as claimed in claim 27, wherein the rendering engine further includes information indicating a cell that corresponds to data passed in from the web server, and wherein the rendering engine initiates a cell application corresponding to the data type.

29. The method as claimed in claim 24, wherein there are provided a plurality of cell applications, each of said cell applications corresponding to a type of data, and wherein there are provided a plurality of data sources, each of said data sources corresponding to one of each of said cell applications.

30. The method as claimed in claim 24, wherein the web server and rendering engine correspond to a page, wherein there is provided a second page, and further comprising the step if, in the rendering engine, responsive to a copy request, providing a copy of at least one cell application to the other page.

31. The method as claimed in claim 30, wherein the other page is on the same web server.

32. The method as claimed in claim 30, wherein the other page is on a different web server.

33. The method as claimed in claim 30, wherein the cell application on the other page includes a reference back to at least one cell.

34. A method for providing cells for a cell rendering and manipulation engine, comprising the steps of:
(A) providing an application layer, including at least one cell application;
(B) providing a data layer including at least one data source, each at least one data source corresponding to the at least one cell application.

35. The method as claimed in claim 34, wherein said data source includes an address for the data to be placed into a cell.

36. The method as claimed in claim 34, further comprising the step of starting the cell application response to a request, and returns formatted data.

37. The method as claimed in claim 34, including the step of providing a plurality of cell applications, each of said cell applications corresponding to a type of data, and providing a plurality of data sources, each of said data sources corresponding to one of each of said cell applications.

38. A method for using cells in a cell rendering and manipulation engine, comprising the steps of:
(A) providing a web server;
(B) providing a rendering engine;
(C) in the rendering engine, receiving information from the web server and starting a foreign cell application and receiving formatted data from the foreign cell application.

39. The method as claimed in claim 38, further comprising the steps of, in the rendering engine, obtaining user information from the web server, and passing user information to the foreign cell application.

40. The method as claimed in claim 38, wherein the rendering engine further includes information indicating a cell that corresponds to data passed in from the web server, and wherein the rendering engine initiates a foreign cell application corresponding to the data type.

41. The method as claimed in claim 38, wherein the web server and rendering engine correspond to a page, and farther comprising the step of, in the rendering engine, responsive to a copy request, providing a copy of at least one foreign cell application to an other page.

42. The method as claimed in claim 41, wherein the other page is on the same web server.

43. The method as claimed in claim 41, wherein the other page is on a different web server.
